(19) United States
(12) Patent Application Publication
(10) Pub. No.: US 2012/0093422 A1
(43) Pub. Date: Apr. 19, 2012

(54) METHOD FOR SORTING BALLS BY IMAGE RECOGNITION

(76) Inventors: Ya-Chen HSU, Dali City (TW); Fang-Chih Tien, Dali City (TW)

(21) Appl. No.: 12/905,037

(22) Filed: Oct. 14, 2010

(51) Int. Cl. G06K 9/68

(52) U.S. Cl. 382/218

(57) ABSTRACT

A method for sorting balls by image recognition comprises the steps of feeding ball, capturing image for a first time, making ball rotate, capturing image for a second time, comparing images, and discharging balls. With the above steps, not only can the balls be sorted into the acceptable and the unacceptable balls, but the unacceptable balls can be sorted into different kinds according to the defects such as scratch, strain, and so on. Hence, effective data can be offered to improve the ball manufacturing process accurately.

### BACKGROUND OF THE INVENTION

1. Field of the Invention

The present invention relates to a method for sorting balls, and more particularly to a method for sorting balls by image recognition.

2. Description of the Prior Art

A first conventional ball roundness sorting machine comprises a feeding apparatus, an inspection apparatus and a dispensing apparatus. The inspection device includes a round disc and a speed controller for controlling the rotation speed of the round disc. The round disc is located under a chute of a feeding box and driven by a DC motor to rotate and includes a stopping plate on an inner side edge thereof, in front of the chute of the feeding box is disposed an obliquity guide plate, and at an inner side of the round disc is further disposed another guide plate. The two guide plates are used to guide the balls on the round disc to be inspected and sorted in turn.

A second conventional ball sorting machine sorts the balls with the following method that a light-emitting unit is used to radiate light on the balls to make the balls reflect a light to be received by a light received unit, and then the balls will be determined whether they have defects by comparing the light intensity for sorting the balls. For example, if the intensity difference of a ball is higher than a predetermined value, the ball surface is determined to have defects.

The above two sorting machines both can sort the balls into two kinds: acceptable and unacceptable, but neither can offer effective analysis data to improve the ball manufacturing process accurately.

The present invention has arisen to mitigate and/or obviate the afore-described disadvantages.

### SUMMARY OF THE INVENTION

The primary objective of the present invention is to provide a method for sorting balls by image recognition which can accurately improve the ball manufacturing process.

Hence, in order to achieve the above objective, a method for sorting balls by image recognition in accordance with the present invention comprises the steps of: feeding ball: feeding a ball to a conveying apparatus in such a manner that a first surface of the ball is exposed; capturing image for a first time: utilizing an image capturing apparatus to capture and store an image of the first surface of the ball; and comparing image: comparing the image of the first surface of the ball with respect to image data in a database to establish data related to acceptable balls, unacceptable balls and kinds of the unacceptable balls.

Preferably, the ball includes at least the first surface and a second surface, the method for sorting balls by image recognition further comprises the steps of making ball rotate and capturing image for a second time, the balls are rotated by the conveying apparatus to make the second surface of the ball protrude out in the step of making ball rotate, a second image capturing apparatus is used to capture and store an image of the second surface of the ball in the step of capturing image for a second time, the captured images of the first surface and the second surface are compared with respect to the image data in the database, respectively in the step of comparing image.

Preferably, the conveying apparatus in the step of feeding ball includes a rotary disc which is made of transparent material and is provided with at least one light source unit to radiate light on the rotary disc to make the first and the second image capturing apparatus capture the images more clearly.

Preferably, the method for sorting balls by image recognition further comprises the step of discharging balls after the step of comparing image, the balls being controlled to fall in different direction according to a result of the step of comparing image.

### BRIEF DESCRIPTION OF THE DRAWINGS

FIG. 1 is a block flow diagram of a method for sorting balls by image recognition in accordance with the present invention;

FIG. 2 is a partial view showing the relation between the feeding apparatus, the balls and the first, second image capturing apparatus in accordance with the present invention; and

FIG. 3 is another partial view showing two light source units are disposed at two opposite sides of the rotary disc of the conveying apparatus.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

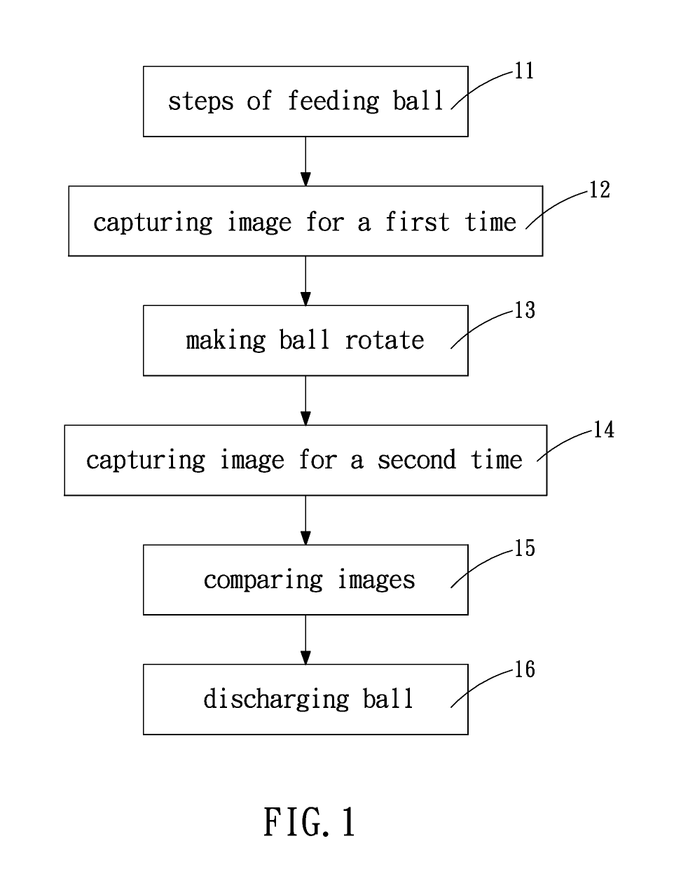

Referring to FIG. 1, a ball sorting method by image recognition in accordance with the present invention comprises the steps of feeding ball 11, capturing image for a first time 12, making ball rotate 13, capturing image for a second time 14, comparing images 15, and discharging ball 16.

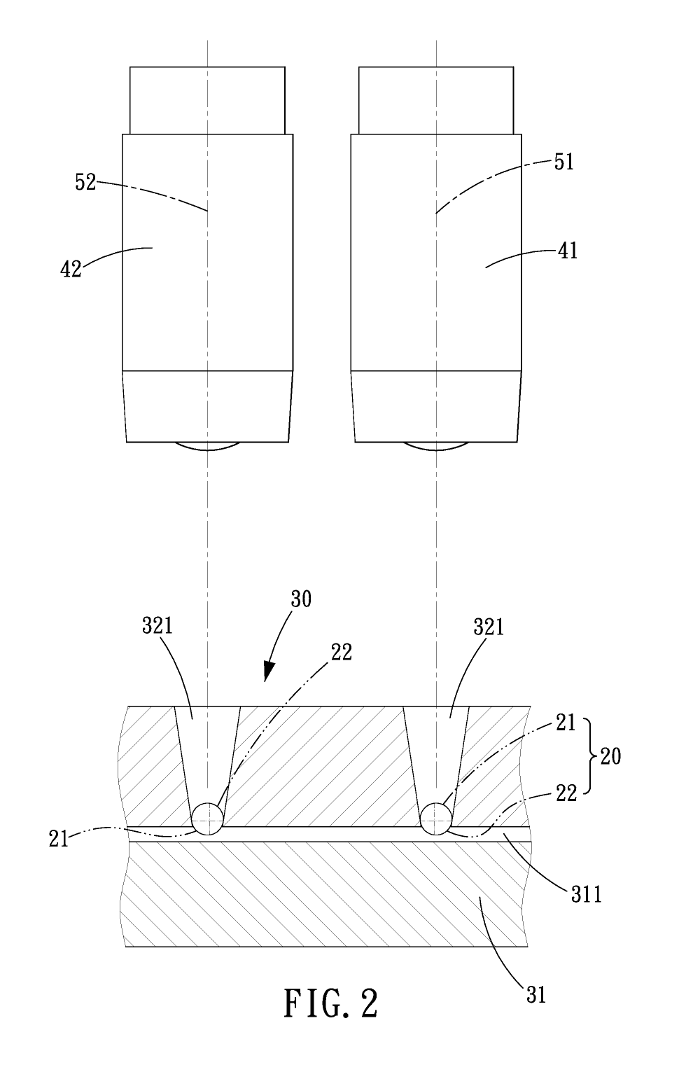

The step of feeding ball 11: referring to FIG. 2, the balls 20 are fed into a conveying apparatus 30. Each of the balls 20 includes a first surface 21 which is exposed out and a second surface 22, and the conveying apparatus 30 includes a chassis 31 including a rolling groove 311, and a rotary disc 32 rotatably disposed on the chassis 31. The rotary disc 32 is allowed to rotate a certain angle and formed with plural circularly-arranged tapered holes 321 which are tapered downwards. Each of the plural tapered holes 321 is provided for accommodation of a single ball 20. The ball 20 is accommodated in the corresponding tapered hole 321 in such a manner that part of the ball 20 is exposed out of the tapered hole 321 and brought into contact with the rolling groove 311. It is to be noted that, the circularly-arranged tapered holes 321 and the related parts are drawn on FIG. 2 in an unfolded manner for easy comprehension.

The step of capturing image for a first time 12: a first image capturing apparatus 41 is used to capture the image of the first surface 21 of the ball 20. The image capturing apparatus 41 is a normal camera. The first image capturing apparatus 41 is disposed at a first position 51 for capturing and storing the image of the first surface 21 of the ball 20. The first position 51 is aligned with the tapered hole 321 of the rotary disc 32.

The step of making ball rotate 13: the balls 20 are rotated by the conveying apparatus 30 to make their second surfaces 22 protrude out. In the present embodiment, the rotary disc 32 of the conveying apparatus 30 is controlled to rotate an angle, and since the balls 20 are restricted in the tapered holes 321 of the rotary disc 30, and part of the ball 20 contacts the rolling groove 311 of the chassis 31, the rotary disc 32 will drive the balls 20 in the tapered holes 321 to roll along the rolling groove 311, making the second surfaces 22 of the balls 20 protrude out of the tapered holes 321.

The step of capturing image for a second time 14: a second image capturing apparatus 42 is used to capture and store the image of the second surface 22 of the ball 20. The second image capturing apparatus 42 is a normal camera and disposed at a second position to capture and store the image of the second surface 22 of the ball 20. The second position 52 is aligned to the tapered hole 321 of the rotary disc 32 which rotates the angle.

The step of comparing images 15: the stored images of the first surface 21 and the second surfaces of the balls 20 are compared with the image data in the database, respectively to establish the data related to the acceptable balls, unacceptable balls, and kinds of unacceptable balls.

The step of discharging balls 16: according to the result from the step of comparing images 15, detecting and classifying the kinds of the balls, including acceptable balls, unacceptable balls with scratch, unacceptable balls with strain, and etc, controlling the respective balls 20 to fall in different directions.

Hence, the sorting method by image recognition in accordance with the present invention can not only sort the balls into two kinds: one is acceptable, and the other is unacceptable but sort the unacceptable balls into different kinds according to the kinds of the defects, such as: scratch, strain, and so on. Thereby, it can establish data of the balls to offer the effective analysis data to improve the ball manufacturing process accurately.

In addition, the present invention can also accurately improve the manufacturing process with the steps of capturing image for a single time and comparing the image with the image data in the database. Of course, capturing the image of the ball for more than two times and comparing the images with respect to the image data in the database are also feasible. The more times the image is captured, the more accurate the result of the comparing is.

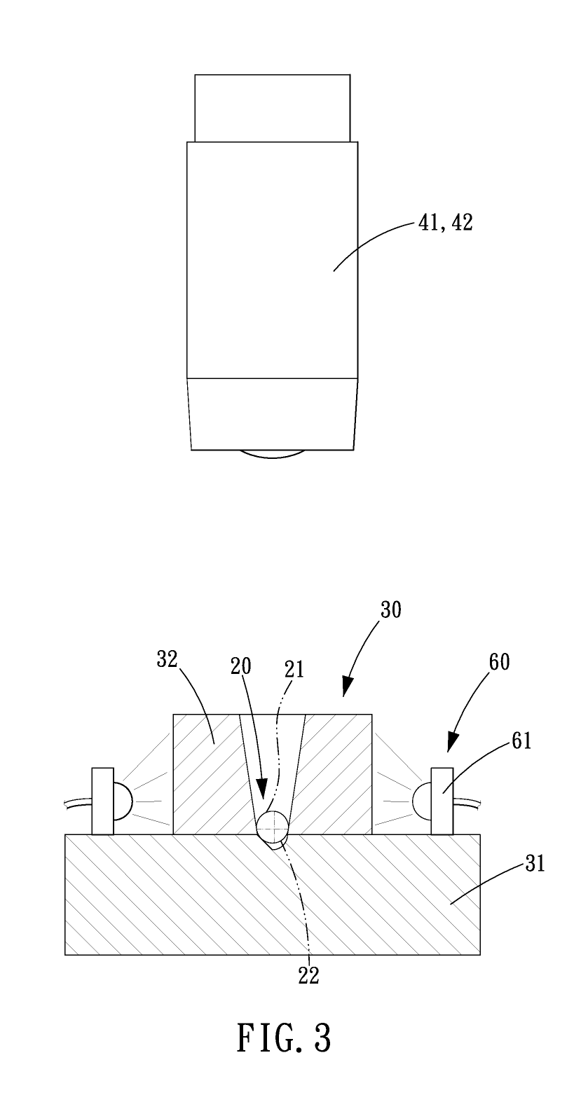

It is to be noted that, referring to FIG. 3, the rotary disc 32 of the conveying apparatus 30 in the present invention is provided with at least one light source unit 60, preferably two light source units 60. The two light source units 60 are disposed at both sides of the rotary disc 32, and each of the light source units 60 include plural light emitting diodes 61. The rotary disc 32 is made of transparent material in the present embodiment, so that when the light source units 60 radiate light on the rotary disc 32, the first and the second image capturing apparatuses 41, 42 can capture the images of the first and the second surfaces 21, 22 more clearly.

While we have shown and described various embodiments in accordance with the present invention, it is clear to those skilled in the art that further embodiments may be made without departing from the scope of the present invention.

What is claimed is:

1. A method for sorting balls by image recognition comprising the steps of:
feeding ball: feeding a ball to a conveying apparatus in such a manner that a first surface of the ball is exposed;
capturing image for a first time: utilizing an image capturing apparatus to capture and store an image of the first surface of the ball; and
comparing image: comparing the image of the first surface of the ball with respect to image data in a database to establish data related to acceptable balls, unacceptable balls and kinds of the unacceptable balls.

2. The method for sorting balls by image recognition as claimed in claim 1, wherein the ball includes at least the first surface and a second surface, the method for sorting balls by image recognition further comprises the steps of making ball rotate and capturing image for a second time, the balls are rotated by the conveying apparatus to make the second surface of the ball protrude out in the step of making ball rotate, a second image capturing apparatus is used to capture and store an image of the second surface of the ball in the step of capturing image for a second time, the captured images of the first surface and the second surface are compared with respect to the image data in the database, respectively in the step of comparing image.

3. The method for sorting balls by image recognition as claimed in claim 2, wherein the conveying apparatus in the step of feeding ball includes a rotary disc which is made of transparent material and is provided with at least one light source unit to radiate light on the rotary disc to make the first and the second image capturing apparatus capture the images more clearly.

4. The method for sorting balls by image recognition as claimed in claim 1 further comprising the step of discharging balls after the step of comparing image, the respective balls being controlled to fall in different direction according to a result of the step of comparing image.

5. The method for sorting balls by image recognition as claimed in claim 2 further comprising the step of discharging balls after the step of comparing image, the respective balls being controlled to fall in different direction according to a result of the step of comparing image.
